(19) United States
(12) Patent Application Publication
(10) Pub. No.: US 2021/0312076 A1
(43) Pub. Date: Oct. 7, 2021

(54) METHOD AND SYSTEM FOR ACCESSING AND PROVIDING MARKET DATA

(71) Applicant: Orcatec LLC, Rancho Santa Fe, CA (US)

(72) Inventor: Alexei Golopapenko, Rancho Santa Fe, CA (US)

(21) Appl. No.: 16/842,504

(22) Filed: Apr. 7, 2020

(51) Int. Cl. G06F 21/62; H04L 29/06; G06Q 30/02

(52) U.S. Cl. CPC G06F 21/6245; G06Q 30/0201; H04L 63/0876

(57) ABSTRACT

A system and method that provide information about one or more clients to a service provider, such as a contractor. The system may also provide competitive information to the service provider. The system comprises a hardware processor configured to obtain client rating information from another service provider. The client rating information is based on actual experience between the other service provider and the one or more clients for which the rating is made. The system further comprises a memory device in communication with the hardware processor and configured to store the client rating information for later retrieval by the hardware processor. The hardware processor is further configured to authenticate the service provider based on credentials provided by the service provider and, if the hardware processor determines that the credentials are valid, permit access by the service provider to the client rating information.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

This disclosure relates to a communications network for allowing service providers, such as contractors, to rate experiences with service recipients, such as clients. Further, this disclosure relates to providing access to competitive market activities by service providers.

### Description of the Related Art

Electronic transactions between service providers and recipients over the Internet and similar communications network have increased significantly in recent years. Contractors now transact business with their clients, such as scheduling, billing, payment, and follow-up, using electronic communications and platforms. Those contractors, however, do not have readily available or reliable data about service experiences with those clients before a service is actually performed. Similarly, those contractors, do not have reliable data about other contractors' business activities in a given market. There is a need for providing service providers with such information remotely over the communications network.

### SUMMARY OF THE INVENTION

In one embodiment, a system for providing information about one or more clients to a first service provider is provided. The system comprises a hardware processor configured to obtain client rating information from a second service provider. The client rating information is based on actual experience between the second service provider and the one or more clients for which the rating is made. The system further comprises a memory device in communication with the hardware processor and configured to store the client rating information for later retrieval by the hardware processor. The hardware processor is further configured to authenticate the first service provider based on credentials provided by the first service provider and, if the hardware processor determines that the credentials are valid, permit access by the first service provider to the client rating information.

In another embodiment, a system for providing competitive information to a first service provider is provided. The system comprises a hardware processor configured to obtain the competitive information from a second service provider. The competitive information relates to business activities of the second service provider with one or more clients in an industry in which the second service provider operates. The system further comprises a memory device in communication with the hardware processor and configured to store the obtained competitive information for later retrieval by the hardware processor. The hardware processor is further configured to authenticate the first service provider based on credentials provided by the first service provider and, if the hardware processor determines that the credentials are valid, permit access by the first service provider to the competitive information.

### BRIEF DESCRIPTION OF THE DRAWINGS

Embodiments of the above-mentioned aspects, as well as other features, aspects, and advantages of the present technology will now be described in connection with various aspects, with reference to the accompanying drawings. The illustrated aspects, however, are merely examples and are not intended to be limiting. Throughout the drawings, similar symbols typically identify similar components, unless context dictates otherwise. Note that the relative dimensions of the following figures may not be drawn to scale. The following drawings and the associated descriptions are provided to illustrate embodiments of the present disclosure and do not limit the scope of the claims.

FIG. 1 is a high-level block diagram of a communications system showing various network components in accordance with one embodiment of the invention.

FIG. 2 is a functional block diagram of the analytics system of the communications network of FIG. 1.

FIG. 3 is a functional block diagram of an exemplary service provider device of the communications network of FIG. 1.

FIG. 4 is a flowchart of the process of rating and accessing reviews of client in accordance with one embodiment of the invention.

FIG. 5 is a flowchart of the process of obtaining and accessing competitive market information in accordance with one embodiment of the invention.

FIG. 6 is a screenshot of an exemplary page showing a sample list of clients with available reviews and/or ratings.

FIG. 7 is a screenshot of an exemplary page showing sample reviews/ratings of clients entered by users of various service providers.

FIG. 8 is a screenshot of a first example of competitive information of the analytics server of FIG. 1.

FIG. 9A and FIG. 9B are screenshots of a second example of competitive information of the analytics server of FIG. 1.

### DETAILED DESCRIPTION OF THE PREFERRED EMBODIMENT

The features, aspects and advantages of the present disclosure will now be described with reference to the drawings of several embodiments which are intended to be within the scope of the embodiments herein disclosed. These and other embodiments will become readily apparent to those skilled in the art from the following detailed description of the embodiments having reference to the attached figures, the development not being limited to any particular embodiment(s) herein disclosed.

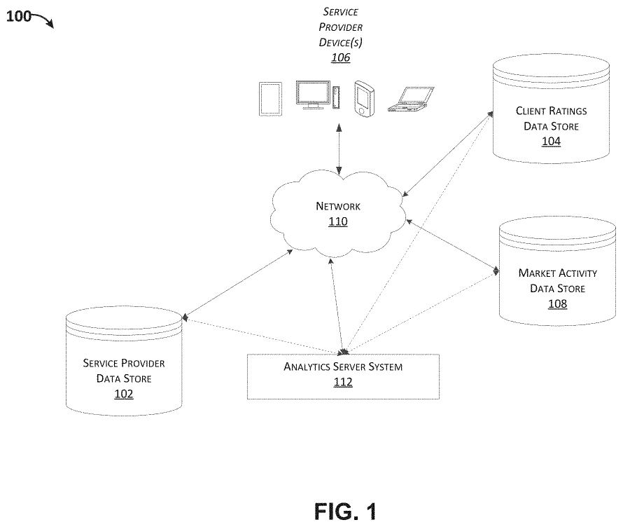

As noted above, FIG. 1 shows a high-level block diagram of a communications system 100 having various network components in accordance with one embodiment of the invention. As shown in FIG. 1, a communications network 110 connects the various network components and is shown as a network cloud that represents any wired and/or wireless network that can be used for communications between two or more communication devices. For instance, the communications network 110 may comprise the public Internet, a private network, a wired network such as a landline based data communications system, a wireless network such as a mobile data network (sometimes referred to as a “cellular” network) or Wi-Fi, or any combination of the foregoing communications networks. The network components shown in FIG. 1 include one or more service provider devices 106 connected to the communications network 110, a service provider data store 102 connected to the communications network 110, a client ratings data store 104 connected to the communications network 110, a market activity data store 108 connected to the communications network 110, and an analytics system or server 102 also shown connected to the communications network 110. Each of these network components may be connected to the communications network 110 via an appropriate network connection interface that may be wired (e.g., using an Ethernet connection) and/or wireless (e.g., using a Wi-Fi or mobile data connection).

The analytics server 112 may comprise any computer or system that provides resources, data, services, or programs to other computers, known as clients, over the communications network 110, which may include one or more web servers, mail servers, and/or file servers. As used herein, a service provider includes any person or entity that provides service to a consumer (i.e., a client), including a contractor who performs any service to a commercial or residential client. The contractor may be an electrician, a plumber, a heating and air-conditioning worker, a painter, a carpenter, remodeler, and any other contractor who provides a service or product to a consumer client. In one embodiment, a contractor would contract or sign up for a service for a subscription fee with the operator of the analytics server 112. The service would include providing by the operator of the analytics server 112 a variety of contractor services to the contractor, including appointment scheduling, billing, payment, and follow-up, using electronic communications over the communications network 110. In addition, the service provided by the analytics server 112 includes allowing the contractor to access reviews or ratings of clients done by other contractors, market activities of other contractors, and market data in a particular geographic area and/or for a specific contractor service or industry (e.g., electric, plumbing, etc.). Thus, when a contractor is connected with a potential client, and the contractor has had no prior experience with (e.g., has not provided any service to) the potential client, the contractor can access valuable client information beforehand using his device 106 over the communications network 110 from the analytics server 112. For instance, the contractor (or a “user” on behalf of the contractor entity) may enter his authentication credentials (e.g., a username and/or password) into a website or an application on his device 106 to access his profile in the analytics server 112. Once authenticated by the analytics server 112, the contractor can view a client list with available reviews. The available reviews may include textual comments with a rating that can be any numeric, symbolic, or chart-based rating, e.g., 1 to 5 stars. The rating represents a combination of reviews by all contractors who previously entered reviews/ratings about that particular client using the analytics server 112. After the contractor provides a product or service to that potential client, the contractor himself may enter his own review and rating about the client. If so, the analytics server 112 provides the contractor with access to the client data by displaying the user name and ability to change or delete his own review and/or rating. If the rating was added by another contractor, the current contractor may only view the review and/or rating without the ability to edit/delete such review and/or rating. Hence, in one embodiment, the contractor has the ability to revise or delete his own review and rating of the client but cannot change or delete a review or rating entered by another contractor. When the review or rating is entered by another contractor, the analytics server 112 does not permit the contractor to view the other contractor(s) name(s) who previously left the reviews or ratings about the client. This concealment of the other contractor(s) name(s) preserves the privacy of the other contractor(s) who previously participated in the review/rating of the client. In one embodiment, the contractor may still be allowed to view the general service field or industry of the other contractor(s) who left the review/rating, e.g., electrical, plumbing etc. For instance, a Contractor A will see personalized feedbacks of its users working for Contractor A, but Contractor A will see only industry segment for reviews/ratings entered by users working for other Contractors B, C, D . . . , or Y.

In addition to allowing contractors to enter and view other contractors' reviews and ratings of clients, the analytics server 112 may provide contractors with information about market activities and competition, e.g., for a subscription fee. In one embodiment, the analytics server 112 provides a contractor with local geographic competition in a selected industry and sector of industry. The contractor can view a list of analytics from those selected industries. The analytics server 112 can display market information in a variety of formats including graphical (charts) and numerical (numbers) formats. The contractor can set a duration of time (e.g., periods) for which analytics are to be displayed. The data of the analytics about the market is gathered from all platforms in the system that meets the display criteria set by the contractor. For instance, in one embodiment, the local market (e.g., competition) shows data sorted by county, city, zip code, state or by a specified distance radius from a desired location. The analytics server 112 obtains such market information from one or more contractors who participate in or subscribe to conducting transactional services using software platform of the operator (e.g., company) of the analytics server 112. The analytics server 112 keeps track of such transactions for each contractor, industry, sector, and geographical metrics. Alternatively, the analytics server 112 may obtain such market information from third party providers or other services.

In one embodiment, the user selects an industry type present in the analytics server 112, e.g., plumbing, HVAC, pest control, electrical, general contracting, or others. The user can select multiple industry types simultaneously for viewing. The user can select a type of industry sector: commercial, residential or both. The user can select a date range from 1 to any desired number of days/weeks/months/years and data will be displayed accordingly. In one embodiment, the kind of competitive or market information includes one or more of the following information: a) most appointments scheduled by one company/contractor from the selected industry type(s) and sector(s); b) the top (e.g., 3) appointment sources per one company/contractor. In one embodiment, when an appointment is initially created with analytics server 112, it is desirable for the user to identify the source of the appointment is being scheduled. In one embodiment, the competitive information displays such appointment sources, without identifying or showing specific company or contractor name. Other data to be displayed by the analytics server 112 may include the top (e.g., 3) appointment types per company, most proposals sold by one company (e.g., contractor) for a selected period in selected industry type(s), most service contracts sold by one company for selected period in selected industry type(s), most expensive proposal sold by one company or contractor for selected period in selected industry type(s), most expensive service contract sold by one company or contractor for a selected period in selected industry type(s), and/or most phone call received by one company for a selected period in selected industry type(s). In another embodiment, the user can select a date range from 1 to any number of days/weeks/months/years to display data for other market information, which may include average cost per sold proposal for the selected period and industry type(s), average cost per sold service contract for the selected period and industry type(s), average number of appointments per source for the selected period and industry type(s), average appointment types per source for the selected period and industry type(s), average phone calls received by a company for the selected period and industry type(s), a line chart showing appointments scheduled for the selected period and industry type(s), a line chart showing number of proposals sold for the selected period and industry type(s), a line chart showing a total cost of proposals sold for the selected period and industry type(s), a line chart showing amount of service contracts sold for the selected period and industry type(s), a line chart showing total cost of service contracts sold for the selected period and industry type(s), and/or a chart of appointment analytics. In one embodiment, the appointment analytics chart shows appointment type(s) and number of appointments by type. Alternatively, the user can select to see data also by appointment sources, periods of time and industry type(s).

As noted above and shown in FIG. 1, the data store 102 communicates with the analytics server 112 directly, or over its connection to the communications network 110, via an appropriate network connection interface that may be wired (e.g., using an Ethernet connection) and/or wireless (e.g., using a Wi-Fi or mobile data connection). The data store 102 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). In one embodiment, the data store 102 is configured to store service provider information, e.g., contractors or contracting companies' profiles, for processing subscription information and for authenticating users of contractors or contracting companies. The profile of such contractors or contracting companies may include contact, billing, authenticating data, and/or subscription details, which are entered by the user and/or obtained and processed by the operator of the analytics server 112. As described above, the analytics server 112 authenticates user(s) of service provider device(s) 106 based on the details stored in the service provider data store 102. Once user information is authenticated and subscription information is validated, the analytics server 112 permits access to the user of the service provider device 106 to access other data stores 104 and 108 across the network.

Further, as noted above and shown in FIG. 1, the data store 104 communicates with the analytics server 112 directly, or over its connection to the communications network 110, via an appropriate network connection interface that may be wired (e.g., using an Ethernet connection) and/or wireless (e.g., using a Wi-Fi or mobile data connection). The data store 104 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). In one embodiment, the data store 104 is configured to store client reviews and ratings in accordance with client profile(s) stored therein. As described above, the reviews and ratings are entered into the analytics server 112 by a contractor or user via the service provider device 106 over the communications network 110. The analytics server 112 coordinates and processes the entered client information for storage in the data store 104 in accordance with and for each client profile. As indicated above, the analytics server 112 also coordinates retrieval of such client information for display to an authorized subscriber or user of the service provider device 106.

Further, as noted above and shown in FIG. 1, the data store 108 communicates with the analytics server 112 directly, or over its connection to the communications network 110, via an appropriate network connection interface that may be wired (e.g., using an Ethernet connection) and/or wireless (e.g., using a Wi-Fi or mobile data connection). The data store 108 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). In one embodiment, the data store 108 is configured to store competitive or market information previously described above. As indicated above, the various competitive or market information is generally processed by the analytics server 112. In one embodiment, the analytics server 112 tracks service (or product) orders placed to each contractor entity using information obtained from scheduling activities of each contractor entity in the service provider data store 102. In another embodiment, the competitive or market information about a particular user may be initially entered by or obtained from the user of the service provider device(s) 106, which are then communicated over the communications network 110 to and processed by the analytics server 112 for storage in and retrieval from the market activity data store 108. Each user market information is categorized and sorted by each user profile sorted in the data store 102.

Although all the data stores 102, 104, and 108 are described above as separate entities communicating with the analytics server 112 over the communications network 110, one or more of the data stores 102, 104, and 108 may be consolidated in a single or multiple co-located data storage device(s) for access by the analytics server 112. Such an alternative configuration may eliminate the need for the communications network 110 to support communication between the data stores 102/104/108 and the analytics server 112. Without the communications network 110, the analytics server 112 communicates with and maintains control of the data stores 102/104/108 directly, i.e., via a direct communication link. In summary, the analytics server 112 coordinates access and exchange of information between the service provider device(s) 106 and the data stores 102, 104, and 108.

Finally, as noted above and shown in FIG. 1, the service provider device(s) 106 communicates with the analytics server 112 over its connection to the communications network 110 via an appropriate network connection interface that may be wired (e.g., using an Ethernet connection) and/or wireless (e.g., using a Wi-Fi or mobile data connection). Each service provider device(s) 106 may comprise any type of mobile or stationary communications device, such as a desktop or laptop personal computer or terminal, a tablet device, a personal data assistant (PDA), a mobile (smart) phone, a kiosk, a smart watch, a car console, a media player, or any other device configured to communicate over the communications network 110 via a wired and/or wireless connection. In one embodiment, the service provider device(s) 106 is configured with a user interface medium, such as an installed web browser or a dedicated application, which permits access to the analytics server 112 via the communications network 110. As described above, a “user” on behalf of the service provider may enter his authentication credentials (e.g., a username and/or password) into the user interface medium on the device 106 to access his profile in the analytics server 112. Once authenticated by the analytics server 112, the user can access his service provider's own profile in the service provider data store 102, client ratings information in the client ratings data store 104, and/or market activity information in the market activity data store 108, in accordance with the conditions described respectively above. As also described above, the client reviews and ratings are entered into the analytics server 112 by the user via the service provider device 106 over the communications network 110. In one embodiment, the client reviews and/or ratings may be obtained from another independent source. The analytics server 112 coordinates and processes the entered client information for storage in the data store 104 in accordance with a particular client profile. The analytics server 112 also coordinates retrieval of such client information for display to the user of the service provider device 106.

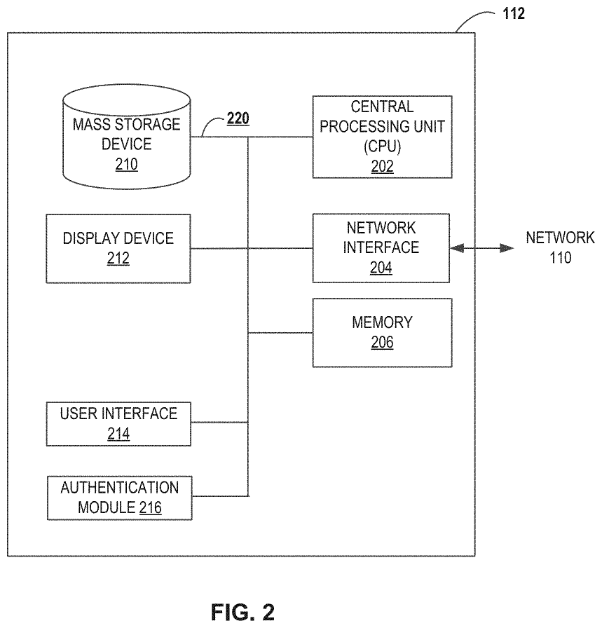

As noted above, FIG. 2 is a functional block diagram of the analytics server 112 of the communications network 100 of FIG. 1. Generally, the analytics server 112 may comprise any computer or system that provides resources, data, services, or programs to other computers, known as clients, over the communications network 110, which may include one or more web servers, mail servers, and/or file servers. In one embodiment, and with reference to FIG. 2, the analytics server 112 comprises a central processing unit (CPU) 202 connected to a physical bus network 220, to which the following physical components/devices are connected: a mass storage device 210, a display device 212, a user interface 214, an authentication module 216, a memory unit 206, and a network interface 204. The CPU 202 may be built into a computer that is IBM, Macintosh, or Linux/Unix model or compatible type, or into a server or workstation or a mobile computing device operating on a suitable operating system. The CPU 202 may control and coordinate operation of all of the foregoing components/devices within the analytics server 112. The CPU 202 may also be referred to as a “processor” or “CPU”, which may comprise or be a component of a processing system implemented with one or more processors. The one or more processors may be implemented with any combination of general-purpose microprocessors, microcontrollers, digital signal processors (“DSPs”), field programmable gate array (“FPGAs”), programmable logic devices (“PLDs”), controllers, state machines, gated logic, discrete hardware components, dedicated hardware finite state machines, or any other suitable entities that can perform calculations or other manipulations of information.

As shown in FIG. 2, the mass storage device 210 and memory unit 206 are two types of storage components that may be found in the analytics sever 112. The memory unit 206 includes one or both of read-only memory (ROM) and random access memory (“RAM”) and may provide instructions and data to the processor 202. For example, data received via inputs received over the communications network 110 by one or more components of the analytics server 112 may be stored in the memory unit 206. A portion of the memory 206 may also include non-volatile random access memory (“NVRAM”). The processor 202 typically performs logical and arithmetic operations based on program instructions stored within the memory 206 in order to perform and achieve the various functions described in connection with the analytics server 112 of FIG. 1 above. The instructions in the memory 206 may be executable to implement the functions of the analytics server 112. In some embodiments, the memory 206 may be configured as a database and may store information that is received via the network interface 204 or the user interface 214.

On the other hand, the mass storage device 210 provides the analytics server 112 with larger storage capacity (compared to the memory unit 206) to accommodate storage for large files and a more permanent storage medium. The mass storage device 210 may also be used to back up all data received or stored in the memory unit 206. The data store 210 may comprise any type of computer memory such as one or more magnetic storage device(s) (e.g., hard disk drive), optical storage device(s) (e.g., CD, DVD, and Blu-ray discs), and/or solid state storage device(s) (e.g., SSDs). The mass storage device 210 may store software or machine instructions for allowing the CPU to process many of the subscriptions, authentication, reviews, ratings, and competitive market information described in connection with FIG. 1 above. Software generally refers to any type of instructions, whether referred to as software, firmware, middleware, microcode, hardware description language, or otherwise. Instructions may include code (for example, in source code format, binary code format, executable code format, or any other suitable format of code). The instructions, when executed by the one or more processors, cause the processing system to perform the various functions described herein. Accordingly, the analytics server 112 includes, for example, hardware and firmware and/or software, or any combination thereof.

The user interface 214 may comprise a keypad, a microphone, a touchpad, a speaker, and/or a touch display, or any other commonly available input/output (“I/O”) devices and interfaces. The user interface 214 may include any element or component that conveys information from the operator of the analytics server 112 to the analytics server 112. In one embodiment, the display device 212 may be combined with or be separate from the user interface 214 and may include one or more display devices, such as a monitor, that allows the visual presentation of data to the operator of the analytics server 112. More particularly, the display device provides for the presentation of GUIs, application software data, websites, web apps, and multimedia presentations, for example.

The network interface 204 provides a communication interface to various external devices directly or over the communications network 110. For example, the analytics server 112 is electronically coupled to the communications network 110 (FIG. 2A), which comprises one or more of a LAN, WAN, and/or the Internet. Accordingly, the network interface 204 includes an interface allowing for communication with the communications network 110, for example, via a wired communication port such as Ethernet, telephone connection, cable television or wired internet access, and/or fiber-optic communication, a wireless communication port, or a combination of both.

In one embodiment, the authentication module 216 comprises a dedicated processor or may be combined within the CPU 202. As described in connection with FIG. 1 above, the authentication module 216 performs the authentication functions of subscriber service providers who sign up (or already signed up) for accessing and receiving the services offered by the analytics server 112. For example, the contractor (or a “user” on behalf of the contractor entity) may enter his authentication credentials (e.g., a username and/or password) into a website or an application on his device 106 to access his profile in the analytics server 112. The authentication module 216 authenticates the entered credentials and, if the credentials pass, the contractor can view a client list with available reviews, enter or update his own reviews/ratings of a client, and/or access market competition information described in connection with FIG. 1 above.

As noted above, communications between the various components or devices within the analytics server 112 are exchanged over the bus network 220. The bus network 220 may include a data bus, for example, as well as a power bus, a control signal bus, and a status signal bus in addition to the data bus. The bus network 220 may be implemented in Peripheral Component Interconnect (“PCI”), Microchannel, Small Computer System Interface (“SCSI”), Industrial Standard Architecture (“ISA”), and/or Extended ISA (“EISA”) architectures, for example. Finally, the functionality provided in the components and devices of the analytics server 112 may be combined into fewer components and devices or further separated into additional components and modules than that shown in FIG. 2.

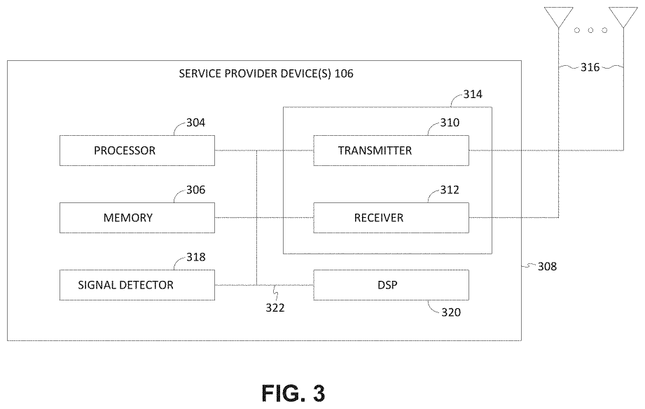

FIG. 3 is a functional block diagram of an exemplary service provider device 106 of the communications network 110 of FIG. The service provider device 106 is an example of a device that may be configured to implement the functions described in connection with the interaction of the user (on behalf of the contractor entity) with the analytics server 112 described in connection with FIG. 1 above. The service provider device 106 may comprise a processor 304 which controls operation of the service provider device 106. In addition to the processor 304, the service provider device 106 comprises a memory 306, which may include both read-only memory (ROM) and random access memory (RAM), provides instructions and data to the processor 304. A portion of the memory 306 may also include non-volatile random access memory (NVRAM). The processor 304 may perform logical and arithmetic operations based on program instructions stored within the memory 306. The instructions in the memory 306 may be executable to implement the functions of the service provider device 106 described above. As shown in FIG. 3, the processor 304 and memory 306 are connected to a physical bus system 322 (similar in function and structure to the bus system 220 of FIG. 2) to exchange communication messages and instructions. The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The service provider device 106 may also comprise a housing 308 that may include a transmitter 310 and a receiver 312 to provide respective transmission and reception of data between the service provider device 106 and the analytics server 112 over the communications network 110. The transmitter 310 and receiver 312 may be combined into a transceiver 314. A single or a plurality of transceiver antennas 316 may be attached to or integrated within the housing 308 and electrically coupled to the transceiver 314. The antennas 316 are provided to allow communications over a wireless medium, such as those accommodating data communication, including Wi-Fi and/or cellular data channels. In an embodiment where the service provider device 106 interfaces with the communications network 110 over a wired medium, the antennas 316 would be replaced with or added to a wired interface such as Ethernet, telephone connection, cable television or wired internet access, and/or fiber-optic communication. The service provider device 106 may also comprise multiple transmitters, multiple receivers, and multiple transceivers (not shown in this figure) to accommodate compatible communications with the communications network 110 and other devices (not shown in this figure). As shown in FIG. 3, each of the transmitter 310 and receiver 312 is connected to the bus system 322 to exchange messages and data with the processor 304, memory 306, and other components within the service provider device 106.

The service provider device 106 may also comprise a signal detector 318 that may be used to detect and quantify the level of signals received by the receiver 312. The signal detector 318 may detect such signals as total energy, energy per subcarrier per symbol, power spectral density and other signals. The service provider device 106 may also include a digital signal processor (DSP) 320 for use in processing incoming and outgoing communication signals, e.g., to confirm the communication signals to suitable or compliant communication protocols. The signal detector 318 may determine if the received signals are of sufficient strength for processing by the DSP 320.

The various components of the wireless communication device 302 may be coupled together by the bus system 322, which may include a power bus, a control signal bus, and a status signal bus in addition to a data bus.

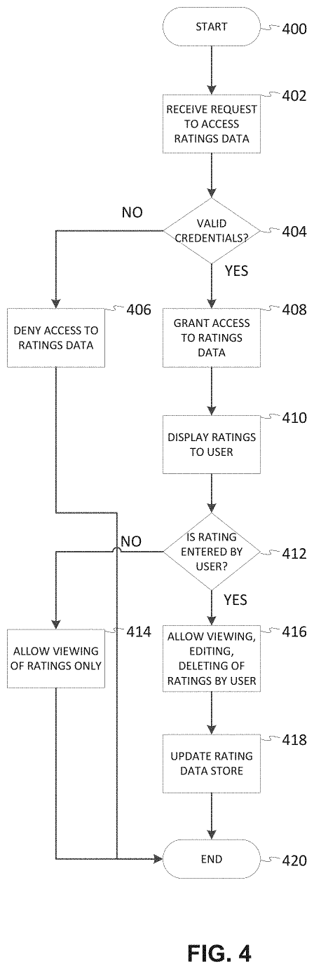

As noted above, FIG. 4 is a flowchart of the process of rating and accessing reviews of client in accordance with one embodiment of the invention. The process begins at block 400. At block 402, the analytics server 112 receives a login request for authentication of a user of a client device 106. As described above, a “user” on behalf of the contractor entity may enter his authentication credentials (e.g., a username and/or password) into a website or an application on his device 106 to access his profile in the analytics server 112. If at decision block 404 the analytics server 112 fails to validate the authentication credentials of the user, the analytics server 112 would (at block 406) deny access to the client ratings data store 104. If at the decision block 404 the analytics server validates the authentication credentials of the user, the analytics server 112 would (at block 408) grant access to the client ratings data store 104. Once authenticated by the analytics server 112, the analytics server 112 grants the user with access at block 408 to view a client list with available reviews. As described above, the analytics server 112 displays available reviews to the user at block 410, which may include textual comments with a rating that can be any numeric, symbolic, or chart-based rating, e.g., 1 to 5 stars. The client rating represents a combination of reviews by all contractors who previously entered reviews/ratings about that particular client using the analytics server 112. At decision block 412, the analytics server 112 determines if it is the current user who previously provided a product or service to a particular client. If the current user did not previously provide such a review/rating about the particular client, then the analytics server 112 would allow the user to only view the review/ratings of the particular client at block 414. In that event, the analytics server 112 does not permit the user to view the other contractor(s) name(s) who previously left the reviews or ratings about the particular client. By hiding the other contractor(s) name(s), the analytics server 112 preserves the confidentiality or privacy of the other contractor(s) who previously participated in the review/rating of the client. As described above, the user may still be allowed to view the general service field or industry of the other contractor(s) who left the review/rating, e.g., electrical, plumbing etc. If at block 412 the analytics server 112 determines that the current user himself has entered the review and rating of the client, the analytics server 112 allows the user at block 416 with full access to the particular client data by displaying the user name and ability to change or delete the user's own review and/or rating. At block 418, the analytics server 112 updates the data store 104 with any new or updated (e.g., edited) client data entered by the current user. Hence, the contractor may revise or delete his own review and rating of the client but cannot change or delete a review or rating entered by another contractor. The process ends at block 420.

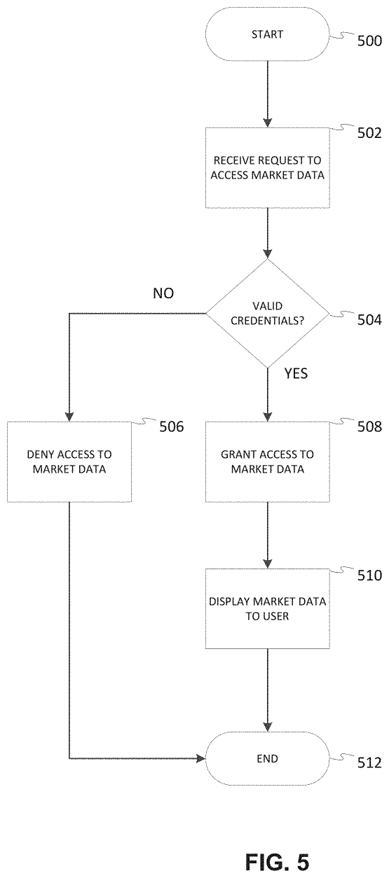

FIG. 5 is a flowchart of the process of obtaining and accessing competitive market information in accordance with one embodiment of the invention. The process begins at block 500. At block 502, the analytics server 112 receives a login request for authentication of a user of a client device 106. As described above, a “user” on behalf of the contractor entity may enter his authentication credentials (e.g., a username and/or password) into a website or an application on his device 106 to access his profile in the analytics server 112. If at decision block 504 the analytics server 112 fails to validate the authentication credentials of the user, the analytics server 112 would (at block 506) deny access to the client ratings data store 104. For instance, the analytics server 112 would check that the user is an authorized subscriber of the competitive market service provided by the operator of the analytics server 112. If at the decision block 504 the analytics server validates the authentication credentials of the user, the analytics server 112 would (at block 508) grant access to the market activity data store 108. Once authenticated by the analytics server 112, the analytics server 112 grants the user with access at block 508 to view a competitive market information about other contractors. As described above, the analytics server 112 tracks service (or product) orders placed for each contractor entity using information obtained from, for instance, scheduling activities of each contractor entity obtained from the service provider data store 102. Alternatively, a user of the client device 106 may initially enter the various competitive market information about its own contractor field activities with various clients. In another embodiment, the analytics server 112 may alternatively or additionally obtain such competitive market information about contractors in various fields from one or more outside sources. In one embodiment, at block 510 the analytics server 112 communicates or directs communication of the analyzed/categorized or updated competitive market information to the data store 108 for storage and later access/retrieval by users of the service provider devices 106 under the supervision and coordination of the analytics server 112. Exemplary details of the competitive market information are provided in connection with FIG. 1 above, and shown in exemplary webpage(s) below. As described above, once access is granted to the user, the analytics server 112 displays available competitive market information to the current user at block 510, which may look like the exemplary page(s) shown and described in connection with the figures below. In one embodiment, the analytic server 112 displays the competitive information to the current user, without identifying or showing specific company or contractor name. This process ends at block 512.

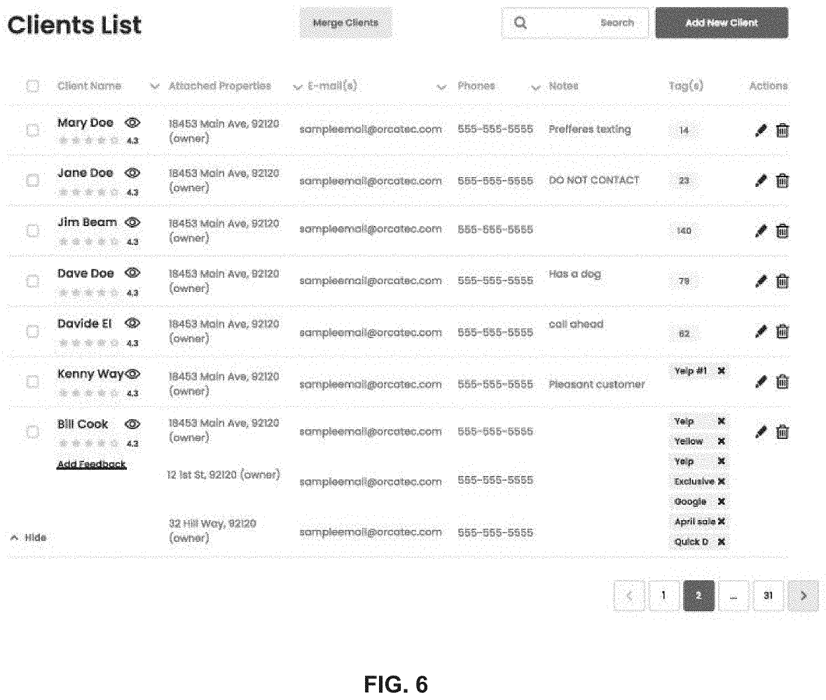

FIG. 6 is a screenshot of an exemplary page showing a sample list of client(s) with available reviews and/or ratings. In this example, the list of client(s) with reviews is shown in a tabular form made up of seven (7) columns. In the first column (beginning left to right) labeled “Client Name”, the name of a client (e.g., “Mary Doe”) is recited in one or more rows indicating that the client Mary Doe has been reviewed/rated on prior occasion(s). A selection box is provided to the left of the client name in each row to allow the user to select an action to be taken for the selected row(s). In the second column labeled “Attached Properties”, the address of a property or properties associated with the client(s) is listed. In the third column labeled “Email(s)”, a contact email is listed for the client in each row. In the fourth column labeled “Phone(s)”, a contact phone number is listed for the client in each row. In the fifth column labeled “Notes”, a field is provided to enter notes about the client review. In the sixth column labeled “Tags” allows notes to be entered for clients to permit retrieval of those clients by a tag search. For example, the term “Allergies” may be entered or associated with the client to identify clients to whom marketing email for air purification may be sent. In the seventh column labeled “Actions”, several actions are provided for the user such as edit or delete functions.

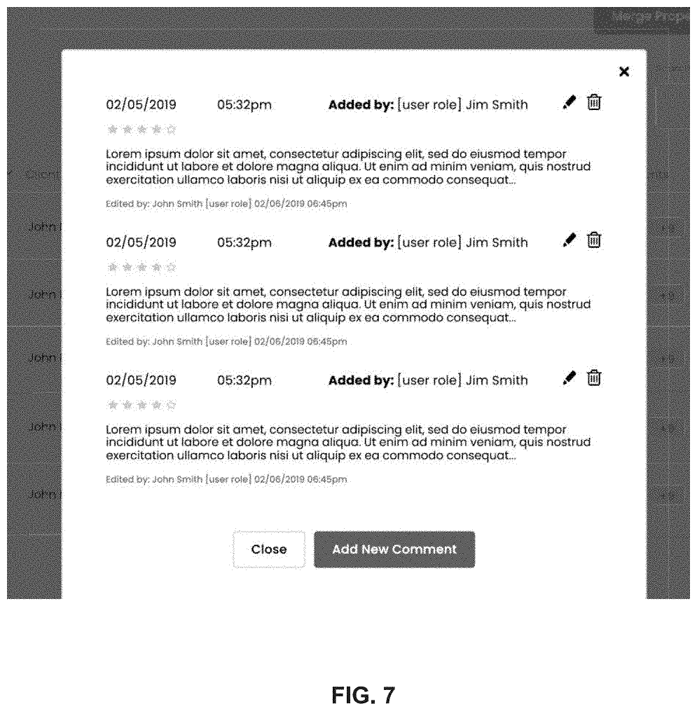

FIG. 7 is a screenshot of an exemplary page showing sample reviews/ratings of clients entered by users of various service providers. As shown in FIG. 7, a pop-up window lists three ratings for a selected client. The reviews show a 4-star rating of the selected client along with the “edit” (shown as a pen symbol) and “delete” (shown as a trash symbol) functions. In this example, the reviews were entered by the same contractor (“Jim Smith”) and Jim Smith is the current viewer of the review/rating of the selected client. Hence, Jim Smith is provided with the ability to edit and/or delete its own reviews/ratings of the selected client using the “edit” and/or “delete” functions. If the review is not entered by Jim Smith (in this example), the row would show review comments by an unnamed contractor in a specific industry (e.g., identified in the “Added by:” field), thereby indicating that the client review in such a row was entered by a contractor that is different from the current viewing contractor (Jim Smith). In such a case, the row would not show the “edit” or “delete” action and, hence, would not allow the current contractor to edit or delete the second review/rating because it was entered by another (i.e., different) contractor. As described in connection with FIG. 1 above, the identity of the other contractor is hidden from, and only the industry or service field is shown to, the current contractor who is viewing this list. In addition to the three rows shown, this window provides a “Add new review” and “Close” virtual buttons on the screen to allow the view contractor to add another review for the selected client or close the pop-up window to go back to the screen shown in FIG. 6 above.

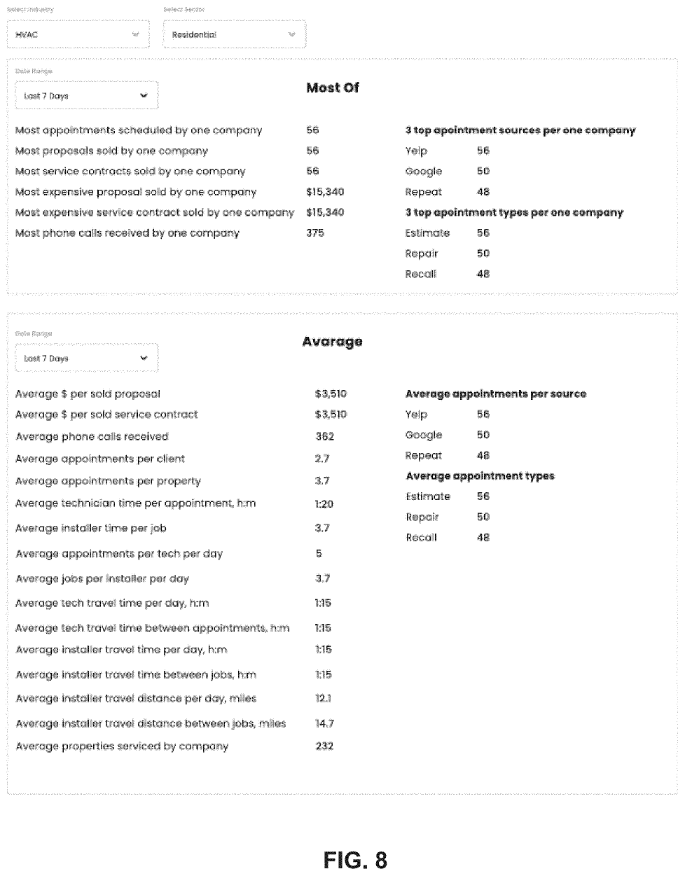

FIG. 8 is a screenshot of a first example of competitive information of the analytics server of FIG. 1. As shown, this exemplary page provides a “Select Industry” and “Select Sector” pull-down menu to allow the user to make respective selections of the foregoing two variables to identify information to be displayed. In addition, this exemplary page provides a “Date Range” to be selected also in a pull-down menu format to allow the user to set a date range for the competitive market data to be displayed. In this example, the page shows the “most appointments scheduled by one company” (56), the 3 top appointment sources per one company, the 3 top appointment types per one company, the most proposals sold by one company, the most service contracts sold by one company, the most expensive proposal sold by one company (in USD, e.g., $15,340), the most expensive Service Contract sold by one company (e.g., $15,340), the most phone calls received by one company (e.g., 375), the average $ per sold proposal (e.g., $3,510), the average $ per sold Service Contract (e.g., $3,510), average appointments per source (e.g., Yelp, Google, Repeat, Referral, TV, etc.), average appointment types (e.g., Repair, Recall, Estimate, Service, Follow-up), and average number of phone calls received (e.g., 362). Additional averages are also shown for other competitive information. The foregoing competitive information represents examples of market data that may be of interest to the user/contractor currently accessing the market activity data store 108. Other market data can be displayed and such information is not limited to those listed in these exemplary pages. The analytics server 112 may also display various market data in graphical or other forms to the user. For instance, and as shown in FIG. 8, a two-dimensional (Y representing number of appointments, and X representing number of days, e.g., over a 30 day period) graph shows the number of appointments scheduled in the selected industry on a particular day of a 30-day duration (e.g., in a particular month or last 30 days). As indicated in FIG. 8, multiple pages are shown to present the foregoing market data, but the data can be presented into any number of pages to the user.

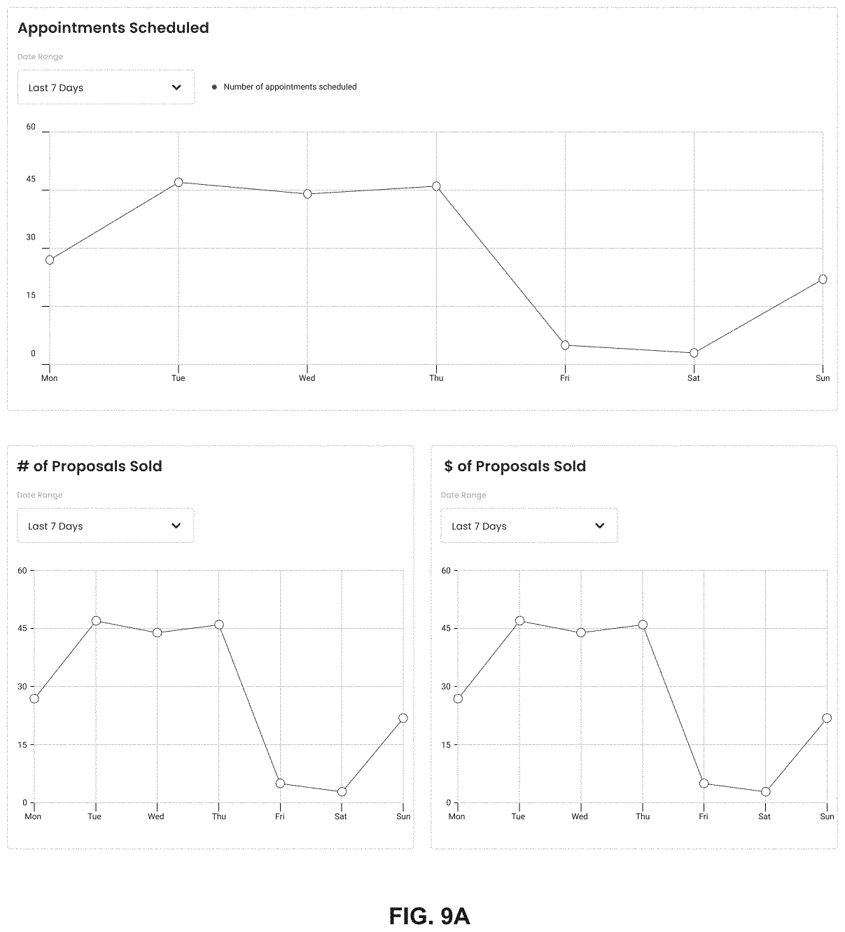

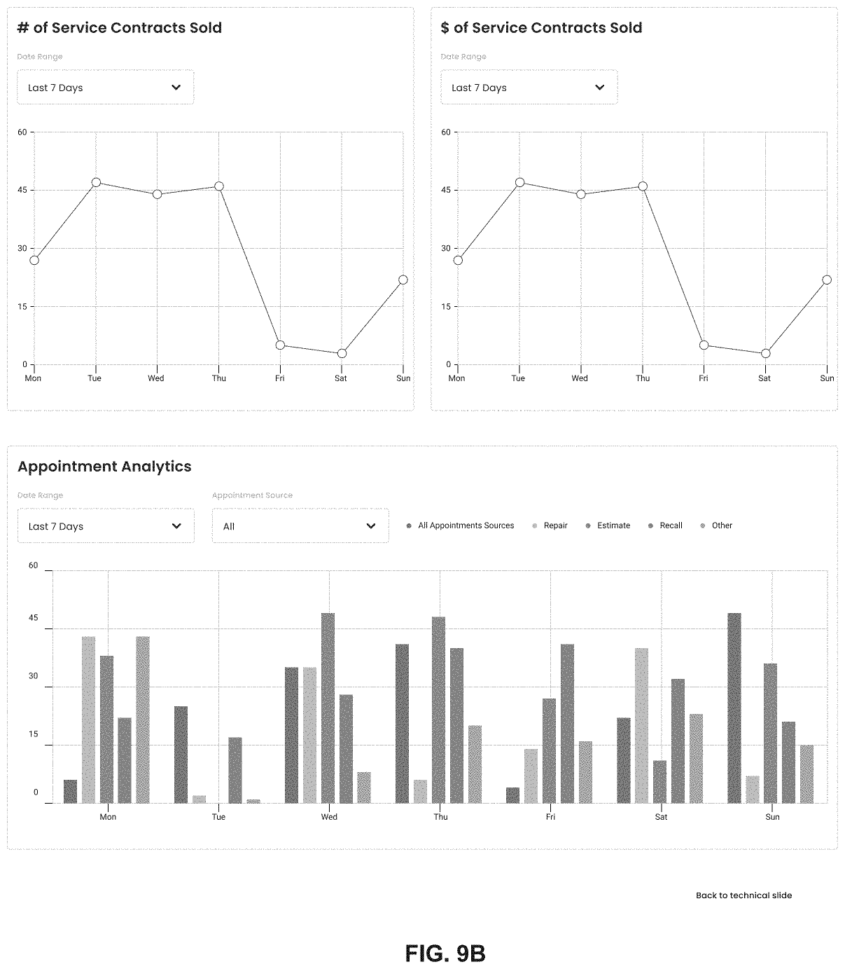

FIG. 9A is a screenshot of a second example of competitive information of the analytics server of FIG. 1. The screenshot shows presentation of competitive market data in graphical form for three (3) market variables: number of appointments scheduled, number of proposals sold, and value ($) of proposals sold. In the top graph of number of appointments scheduled, the graph shows the actual number appointments scheduled along the vertical (Y) axis and number of days (e.g., 7 days of the week in the selected period for display) along the horizontal (X) axis. In the graph of number of proposals sold, the graph shows the actual number sold along the vertical (Y) axis and number of days (e.g., 7 days in the selected period for display) along the horizontal (X) axis. In the graph of the value ($) of proposals sold, the graph shows the actual cumulative value ($) sold along the vertical (Y) axis and number of days (e.g., 7 days in the selected period for display) along the horizontal (X) axis. For the last graph, the period selected for display of such appointments is for the “last 7 days” as shown in a drop down menu. As noted above, the user has the ability to display such market information by appointment source.

FIG. 9B is a screenshot of a third example of competitive information of the analytics server of FIG. 1. The screenshot shows presentation of competitive market data in graphical form for three (3) market variables: number of service contracts sold, value ($) of service contracts sold, and appointment analytics. In the graph for number of service contracts sold, the graph shows the actual number sold along the vertical (Y) axis and number of days along the horizontal (X) axis per the date range selected in the drop down menu (e.g., last 7 days). Similarly, in the graph for value of service contracts sold, the graph shows the actual cumulative value ($) for each day along the vertical (Y) axis and number of days along the horizontal (X) axis. Finally, the last graph shows analytics of appointments made for an industry type(s) or field of service(s) with number of appointments along the vertical (Y) axis and day of the week (e.g., Monday through Sunday) shown along the horizontal (X) axis. In this instance, the graph shows the number of “all appointment types”, “repair”, “estimate”, “recall”, and “other” type of appointments in a bar graph format. For the last graph, the period selected for display of such appointments is also for the “last 7 days” as shown in a drop down menu. As noted above, the user has the ability to display such market information by appointment source.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof. Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein, e.g., functional block diagrams in FIGS. 1-5 above, can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable devices that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some, or all, of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language such as, among others, “can,” “could,” “might” or “may,” unless specifically stated otherwise, are otherwise understood within the context as used in general to convey that certain embodiments include, while other embodiments do not include, certain features, elements and/or blocks. Thus, such conditional language is not generally intended to imply that features, elements and/or blocks are in any way required for one or more embodiments or that one or more embodiments necessarily include logic for deciding, with or without user input or prompting, whether these features, elements and/or blocks are included or are to be performed in any particular embodiment.

Disjunctive language such as the phrase “at least one of X, Y, or Z,” unless specifically stated otherwise, is otherwise understood with the context as used in general to present that an item, term, and so forth, may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following.

What is claimed is:

1. A system for providing information about one or more clients to a first service provider, the system comprising:
a hardware processor configured to obtain client rating information from a second service provider, the client rating information being based on actual experience between the second service provider and the one or more clients for which the rating is made; and
a memory device in communication with the hardware processor and configured to store the client rating information for later retrieval by the hardware processor, wherein the hardware processor is further configured to authenticate the first service provider based on credentials provided by the first service provider and, if the hardware processor determines that the credentials are valid, permit access by the first service provider to the client rating information.

2. The system of claim 1, wherein the hardware processor obtains the client rating information from the second service provider over a communications network that comprises a wired and/or wireless network.

3. The system of claim 1, wherein the hardware processor is further configured to determine if the first service provider is different from the second service provider and, if the first and second service providers are different, conceal identity of the second service provider from the first service provider when accessing the client rating information.

4. The system of claim 1, wherein the hardware processor is further configured to determine if the first service provider is the same as the second service provider and, if the first and second service providers are the same, permit the first service provider to edit or delete the client rating information.

5. The system of claim 1, wherein the hardware processor is configured to obtain the client rating information from a plurality of service providers, including the second service provider, about the one or more clients, and coordinate organizing in the memory device the obtained client rating information as a function of each client, and generate for each client of the plurality of clients a collective client rating based on the client rating information obtained from the plurality of service providers.

6. The system of claim 1, wherein the hardware processor is configured to control storage of and access to the client rating information in the memory device over a wired and/or wireless network.

7. The system of claim 1, wherein the memory device comprises a first data storage device for storing information about the first and second service providers and a second data storage device for storing information about the one or more clients for which the rating information is made.

8. The system of claim 1, wherein the hardware processor is configured to process transactions associated with services provided by the first and second service providers.

9. The system of claim 8, wherein the hardware processor is configured to prompt the second service provider to provide client rating information about the one or more clients after the conclusion of the services to the one or more clients.

10. The system of claim 1, wherein the hardware processor comprises a web server configured to interact with the first and second service providers via a web or dedicated application installed in a communications device accessible by the first and second service providers, respectively.

11. A system for providing competitive information to a first service provider, the system comprising:
a hardware processor configured to obtain the competitive information from a second service provider, the competitive information relating to business activities of the second service provider with one or more clients in an industry in which the second service provider operates; and
a memory device in communication with the hardware processor and configured to store the obtained competitive information for later retrieval by the hardware processor, wherein the hardware processor is further configured to authenticate the first service provider based on credentials provided by the first service provider and, if the hardware processor determines that the credentials are valid, permit access by the first service provider to the competitive information.

12. The system of claim 11, wherein the hardware processor obtains the competitive information from the second service provider over a communications network that comprises a wired and/or wireless network.

13. The system of claim 11, wherein the hardware processor is configured to hide identity of the second service provider from the first service provider when the first service provider accesses the competitive information about the second service provider's activities with the one or more clients.

14. The system of claim 11, wherein the hardware processor is further configured to determine averages associated with competitive information as a function of contractor, price of proposal or service, industry, type of service, number of calls received or made, travel time, distance from contractor or client location, and/or day(s) of the week.

15. The system of claim 11, wherein the hardware processor is further configured to conceal identity of the second service provider from the first service provider when accessing the competitive information.

16. The system of claim 11, wherein the hardware processor is configured to coordinate organizing in the memory device the obtained competitive information as a function of all service providers in a particular industry.

17. The system of claim 11, wherein the hardware processor is configured to control storage of and access to the competitive information in the memory device over a wired and/or wireless network.

18. The system of claim 11, wherein the hardware processor is configured to provide a computerized platform for the second service provider to conduct its business transactions with one or more clients and derive the competitive information based on said business transactions.

19. The system of claim 11, wherein the hardware processor is configured to process transactions associated with services provided by the first and second service providers and to derive the competitive information based on said processed transactions.

20. The system of claim 11, wherein the hardware processor comprises a web server configured to interact with the first and second service providers via a web or dedicated application installed in a communications device accessible by the first and second service providers, respectively.
